(19) United States
(12) Patent Application Publication
(10) Pub. No.: US 2018/0097343 A1
(43) Pub. Date: Apr. 5, 2018

(54) METHOD AND APPARATUS FOR REPAIRING INSULATION FOR WIRING

(71) Applicants: Saad Khan, South Amboy, NJ (US); Zain Khan, South Amboy, NJ (US)

(72) Inventors: Saad Khan, South Amboy, NJ (US); Zain Khan, South Amboy, NJ (US)

(21) Appl. No.: 15/282,192

(22) Filed: Sep. 30, 2016

(51) Int. Cl. H02G 1/16; B29C 65/66; B29C 65/00; B29C 73/04

(52) U.S. Cl. CPC H02G 1/16; B29C 65/66; B29L 2031/3462; B29C 73/04; B29C 66/53241

(57) ABSTRACT

An apparatus including a first hollow tube having an inner chamber and an outer peripheral surface, a cable having outer insulation and an inner conductor wire, and a hand held device for blowing hot air. The first hollow tube may have an inner diameter which is greater than an outer diameter of the cable so that the first hollow tube can be slid over the cable, so that a portion of the cable resides in the inner chamber of the first hollow tube in a first state. The cable may have a length which is substantially greater than a length of the first hollow tube. The hand held device for blowing hot air may be configured to blow hot air on the outer peripheral surface of the first tube, in the first state, to cause the first tube to shrink and become attached to the cable to repair a defect in the cable.

### FIELD OF THE INVENTION

This invention relates to improved methods and apparatus concerning repairing insulation for wiring, such as insulation for electrical conductor wiring, television cables, and cellphone charger cables.

### BACKGROUND OF THE INVENTION

There are various devices known for repairing insulation for wiring or cables.

### SUMMARY OF THE INVENTION

One or more embodiments of the invention provide an apparatus comprising a first hollow tube having an inner chamber and an outer peripheral surface, a cable having outer insulation and an inner conductor wire, and a hand held device for blowing hot air.

The first hollow tube may be configured to have an inner diameter which is greater than an outer diameter of the cable so that the first hollow tube can be slid over the cable, so that a portion of the cable resides in the inner chamber of the first hollow tube in a first state. The first hollow tube may have a length; and the cable may have a length which is substantially greater than the length of the first hollow tube. The hand held device for blowing hot air may be configured to blow hot air on the outer peripheral surface of the first tube, in the first state, to cause the first tube to shrink and become attached to the cable to repair a defect in the cable.

The hand held device for blowing hot air may be a hair dryer. The length of the first hollow tube may be approximately equal to a width of an opening of a first device which can be attached or detached from the hand held device for blowing hot air, and wherein hot air is blown out of the opening of the first device, in the first state.

The apparatus may further include a second hollow tube having an inner chamber and an outer peripheral surface; wherein the second hollow tube is configured to have an inner diameter which is greater than an outer diameter of the cable so that the second hollow tube can be slid over the cable, so that a portion of the cable resides in the inner chamber of the second hollow tube in a first state; wherein the second hollow tube has a length; wherein the cable has a length which is substantially greater than the length of the second hollow tube; wherein the hand held device for blowing hot air can be configured to blow hot air on the outer peripheral surface of the second hollow tube, in the first state, to cause the second hollow tube to shrink and become attached to the cable to repair a defect in the cable; wherein the length of the second hollow tube is approximately equal to a width of an opening of a second device which can be attached or detached from hand held device for blowing hot air, wherein hot air is blown out of the opening of the second device, in the first state, and wherein the length of the first hollow tube and the length of the second hollow tube are different.

In one or more embodiments, a method is provided which may include the steps of sliding a first hollow tube over a first cable so that a portion of the first cable resides in an inner chamber of the first hollow tube in a first state; and blowing hot air on an outer surface of the first hollow tube in the first state, to thereby shrink the first hollow tube to cause the first hollow tube to become attached to an outer surface of the first cable, and to thereby repair a defect in the first cable.

The first hollow tube may be configured to have an inner diameter which is greater than an outer diameter of the first cable so that the first hollow tube can be slid over the first cable, so that a portion of the first cable resides in the inner chamber of the first hollow tube in the first state; wherein the first hollow tube has a length; and wherein the first cable has a length which is substantially greater than the length of the first hollow tube.

The step of blowing hot air on an outer surface of the first hollow tube in the first state may include blowing hot air from a hand held device, such as a hair dryer. The length of the first hollow tube may be approximately equal to a width of an opening of a first device which can be attached or detached from a hand held device for blowing hot air, and wherein the step of blowing hot air on an outer surface of the first hollow tube in the first state includes blowing hot air out of the opening of the first device attached to the hand held device for blowing hot air.

The method may further include sliding a second hollow tube over a second cable so that a portion of the second cable resides in an inner chamber of the second hollow tube in a first state; and blowing hot air on an outer surface of the second hollow tube in the first state, to thereby shrink the second hollow tube to cause the second hollow tube to become attached to the second cable, and to thereby repair a defect in the second cable.

The second hollow tube may be configured to have an inner diameter which is greater than an outer diameter of the second cable so that the second hollow tube can be slid over the second cable, so that a portion of the second cable resides in the inner chamber of the second hollow tube. The second hollow tube may have a length; and the second cable may have a length which is substantially greater than the length of the second hollow tube. The cable may have length which is substantially greater than the length of the second hollow tube. The length of the second hollow tube may be approximately equal to a width of an opening of a second device which can be attached or detached from the hand held device for blowing hot air, wherein hot air is blown out of the opening of the second device. The length of the first hollow tube and the length of the second hollow tube may be different.

### BRIEF DESCRIPTION OF THE DRAWINGS

FIG. 1 shows a side view of an apparatus including two end connectors, insulation, and a wire or conductor inside of the insulation, with the insulation shown as transparent so that the internal wire or conductor can be seen, and wherein the insulation has a cut, gash, or break in it exposing a portion of the wire or conductor;

FIG. 2A shows a front, top, right side view of an insulation tube for use in accordance with an embodiment of the present invention;

FIG. 2B shows a rear, bottom, and left side view of the insulation tube of FIG. 2A;

FIG. 2C shows a right side view of the insulation tube of FIG. 2A;

FIG. 2D shows a left side view of the insulation tube of FIG. 2A;

FIG. 3A shows the apparatus of FIG. 1 with the insulation tube of FIG. 2A surrounding the cut, gash, or break in the insulation of the apparatus of FIG. 1, and a hair dryer applying heat;

FIG. 3B shows a cross sectional view of the insulation tube of FIG. 2A surrounding the cut, gash, or break in the insulation of the apparatus of FIG. 1, along the line A-B;

FIG. 3C shows the apparatus of FIG. 1 with the insulation tube of FIG. 2A surrounding the cut, gash, or break in the insulation of the apparatus of FIG. 1, but with the insulation tube shrunken after heat has been applied; and

FIG. 4 shows the insulation tube of FIG. 2A and another insulation tube which may be identical except for having a different width, and two attachments of different sizes for applying different amounts of heat or applying heat in different ways.

### DETAILED DESCRIPTION OF THE DRAWINGS

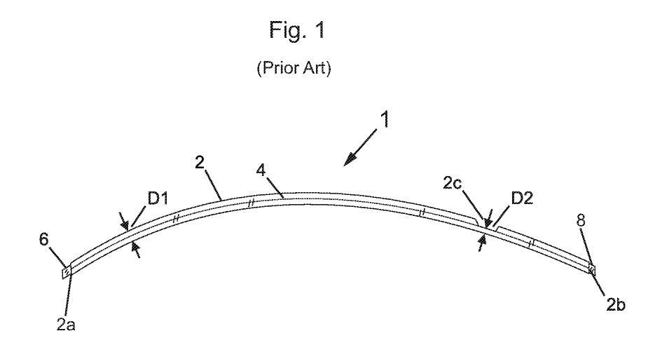

FIG. 1 shows a side view of a prior art apparatus 1 including two opposing end connectors 6 and 8, insulation 2, and a wire or conductor 4 (shown by dashed lines) inside of the insulation 2, with the insulation 2 shown as transparent so that the internal wire or conductor 4 can be seen, and wherein the insulation 2 has a cut, gash, or break 2c in it exposing a portion of the wire or conductor 4. The insulation 2 may have opposing ends 2a and 2b. The opposing end connectors 6 and 8 may connect to opposing ends of the electrical conductor wire 4. The insulation 2 may have an outer diameter D1, which may be about one quarter of an inch or any other known outer diameter for wire insulation. A outer diameter D2 may be located at the gash or cut 2c, and this may be less than D1, such as for example, one eighth of an inch.

The apparatus 1 may be electrical conductor wiring including insulation, a television cable, a cellphone charger cable or any cable that has insulation, such as insulation 2, which can be damaged.

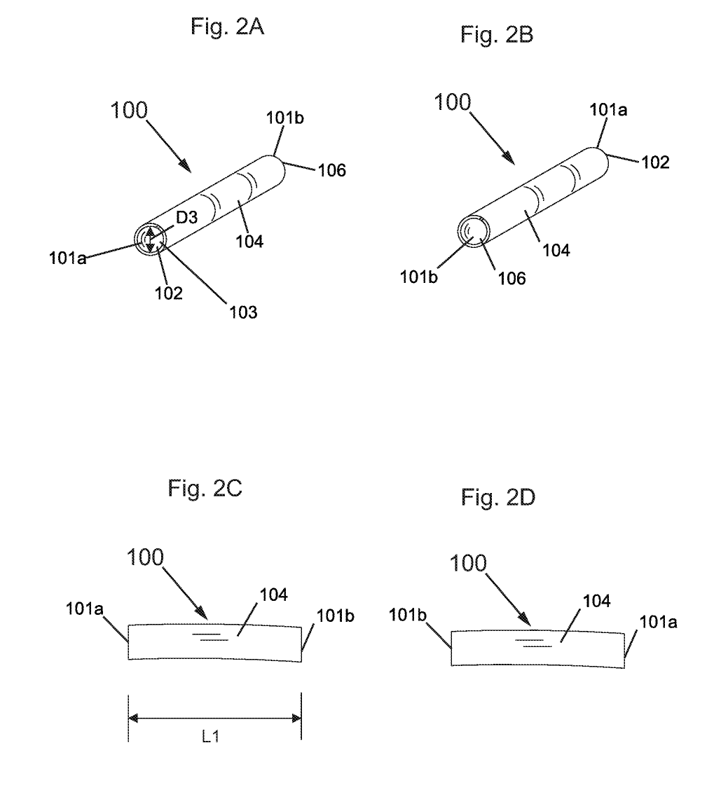

FIG. 2A shows a front, top, right side view of an insulation tube 100 for use in accordance with an embodiment of the present invention. FIG. 2B shows a rear, bottom, and left side view of the insulation tube 100. FIG. 2C shows a right side view of the insulation tube 100. FIG. 2D shows a left side view of the insulation tube 100. The insulation tube 100 includes end 101a and opposing end 101b, and body portion or hollow cylindrical shell 104. The insulation tube has openings 102 and 106 leading to an inner chamber 103 within the shell or body portion 104.

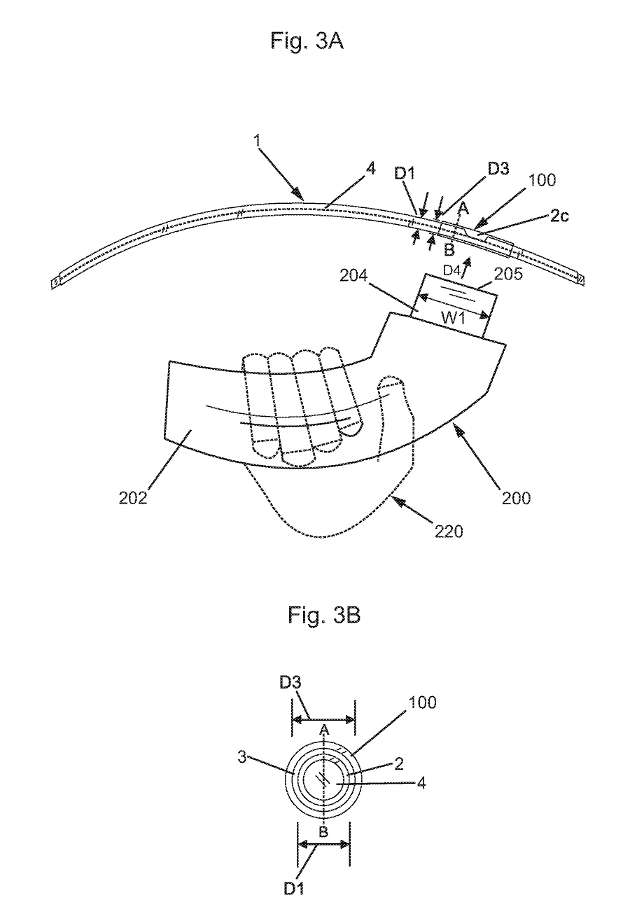

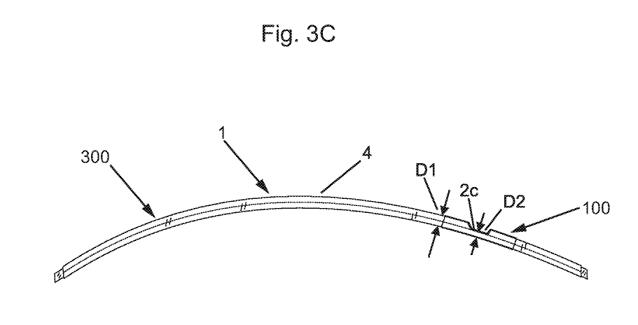

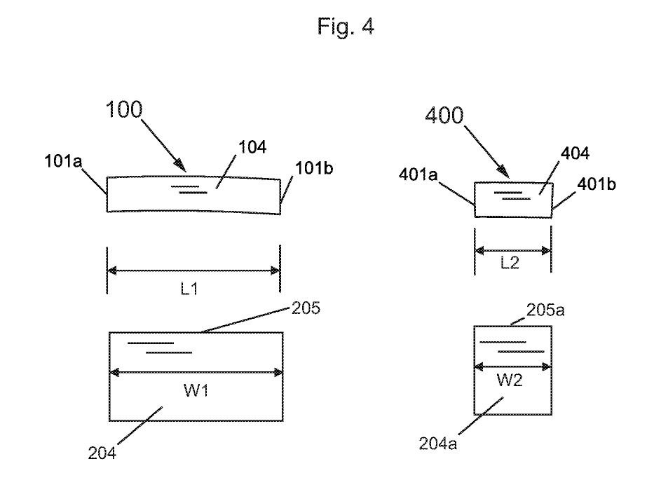

FIG. 3A shows the apparatus 1 of FIG. 1 with the insulation tube 100 of FIG. 2A surrounding the cut, gash, or break 2c in the insulation of the apparatus 1, and a hand held device for blowing hot hair, such as a hair dryer 200 applying heat in a direction D4 at the outer shell 104 of the tube 100. The hair dryer 200 may have a handle 202, and a portion 204 which may be removably attached to the handle 202. The handle 202 can be gripped by one hand, such as hand 220 shown in FIG. 3A, of a human being. The portion 204 may have an opening 205 which has a width of W1, which may be about equal to the length L1 of the tube 100, shown in FIG. 4; and this is critical in one or more embodiments to provide substantially equal heating along the entire length L1 of the tube 100, so the entire tube 100 is heated and shrinks in a consistent manner. The length L1 of the tube 100, in at least one embodiment, may be about two inches, which may corresponding to a width W1 of about two inches for the opening 205. The portion 204 may be pressed against the outer surface of the tube 100, in order to hold the tube 100 in place while the hand held device for blowing hot air or hair dryer 202 is blowing hot air in direction D4 shown in FIG. 3A, i.e. the portion 204 may contact the tube 100 while heat is being applied.

In one or more further embodiments, the tube 100 can be used to cover part of the insulation 2, in locations where there is no cut, gash, break or other defect, in order to provide further protect the cable or apparatus 1 from damage. This can be done to prolong the life of cables or strengthen cables, even if the cables are not currently damaged.

However, in one or more embodiments, the width W1 of the portion 204 may be substantially more or substantially less than the width of the tube 100. If the width W1 of the portion 204 is substantially less, heat can be applied to one part of the tube 100, until in shrinks, in one example, and then heat applied to another part of the tube 100 until it shrinks.

In addition, it is critical, in one or more embodiments, that the width W1 of the portion 204 be approximately equal to or greater than the length L1 of the tube 100, so that the portion 204 can be used to press against the tube 100 and thereby hold the tube 100 in place, while the tube 100 is being heated, i.e. the portion 204 overlaps the entire tube 100 along the length L1, and along the width W1 of the portion 204, so that tube 100 remains in place pressed against the conductor 4 and/or insulation 2.

FIG. 3B shows a cross sectional view of the insulation tube 100 of FIG. 2A surrounding the insulation 2 and the wire 4 of the apparatus 1 along the line A-B, shown in FIGS. 3A and 3B. There is a gap 3, shown in FIG. 3B, between the tube 100 and the insulation tube 2. The insulation tube 100 has an inner diameter, D3, which is greater than the outer diameter of the insulation 2 of the apparatus 1, to allow the tube 100 to slide onto the apparatus 1, and over connectors 6 and 8. The inner diameter D3, of the tube 100 should be configured to be large enough to allow the tube 100 to slide over any connectors of a particular wire with insulation, in one or more embodiments.

FIG. 3C shows the apparatus 1 with the insulation tube 100 surrounding the cut, gash, or break 2c in the insulation 2 of the apparatus 1, but with the insulation tube 100 shrunken after heat has been applied by the hair dryer 200. The insulation tube 100 may shrink so that now it has different diameters as different locations, in order to snugly cover the cut or gash 2C. For example, the insulation tube 100 may have an inner diameter of about D1 after heating, approximately equal to the outer diameter of the insulation 2, where there is no gash 2c, and a smaller inner diameter approximately equal to D2, where the gash or cut 2c was or is located.

FIG. 4 shows the insulation tube 100 and another insulation tube 400 which may be identical except for having a different length, L2 and two attachments 204 and 204a of different sizes for applying different amounts of heat or applying heat in different ways. The attachment 204 may have an opening 204a having a width of W1 for an opening which applies heat. The attachment 204 may be a tube or cylinder having a diameter of W1. The attachment 204a may be identical to attachment 204 but have a different diameter or width W2 which is approximately the same as the length L2 of the tube 400.

Thus a plurality of attachment devices for hair dryer 200 can be provided for applying heat over a width corresponding to a width of an insulation for achieving optimum heating or shrinking in one or more embodiments of the present invention.

The tubes 100 and 400 may be different sizes and may be cut from long heat shrink wire tubing which is generally known in the art, and used by manufacturers to make cable wiring and insulation.

One or more embodiments of the present invention include a method of protecting cable wires from damage, securing and repairing already damaged, exposed cable wires. The method may include using a hair dryer, such as hair dryer 200, which may be a known hair dryer, except that attachments 204 and 204a, or any number of further attachments, may be specially configured to correspond in width, diameter or other dimension to tubes 100 and 200, and any further number of tubes, respectively.

The tubes 100 and 400 may or may not contain an adhesive layer on the inner walls of the tubes 100 and 400. In some embodiments, adhesive may not be used on the inner walls of the tubes 100 and 400. The tube 100, in at least one embodiment Is slid onto and over the insultation 2 of the apparatus 1, through an open end, such as through opening 102 or 106, positioned accordingly, and in at least one embodiment, held down with the front end, at opening 205, of attachment 204 of hair dryer 200. The hair dryer 200 Is then turned on until the tubing 100 has shrunk and has formed an unmoving tight cover over the wire 4 and the insulation 2. In one or more embodiments, this prolongs the life of any cable/wire and can be done by anybody with a hair dryer.

The tubing 100 or 400 may be made entirely or substantially of a material called: “polyolefin heat shrink” and it can be made to any size. The “shrinkable sizes” or “ratios” of this material that can be purchased vary. The most popularly manufactured shrinkable ratios are 2:1, 3:1, and 4:1 (the tubing will shrink down to ½, ⅓rd or ¼th of its original size). All shrinkable sizes can be made with an adhesive layering or without. The adhesive layering typically comes in three additional sizes: “thin wall adhesive lining”, “medium wall adhesive lining”, and “heavy wall adhesive lining”. These are made specifically for protection from the environment. for example if the wire will be exposed to rain, the adhesive layer will form a tight seal so the wire is protected from water.

There is also a fabric version that can be used for tube 100 or 400 called “fabric heat shrink tubing”. which basically uses a mixture of polyolefin weft and polyester warp yarns woven together to form a shrinkable fabric tubing.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first hollow tube having an inner chamber and an outer peripheral surface;
a cable having outer insulation and an inner conductor wire; and
a hand held device for blowing hot air; and
wherein the first hollow tube is configured to have an inner diameter which is greater than an outer diameter of the cable so that the first hollow tube can be slid over the cable, so that a portion of the cable resides in the inner chamber of the first hollow tube in a first state;
wherein the first hollow tube has a length;
wherein the cable has a length which is substantially greater than the length of the first hollow tube;
and wherein the hand held device for blowing hot air can be configured to blow hot air on the outer peripheral surface of the first tube, in the first state, to cause the first tube to shrink and become attached to the cable.

2. The apparatus of claim 1 wherein
the hand held device for blowing hot air is a hair dryer.

3. The apparatus of claim 1 wherein
the length of the first hollow tube is approximately equal to a width of an opening of a first device which can be attached or detached from the hand held device for blowing hot air, and wherein hot air is blown out of the opening of the first device, in the first state.

4. The apparatus of claim 3 further comprising
a second hollow tube having an inner chamber and an outer peripheral surface;
wherein the second hollow tube is configured to have an inner diameter which is greater than an outer diameter of the cable so that the second hollow tube can be slid over the cable, so that a portion of the cable resides in the inner chamber of the second hollow tube in a first state;
wherein the second hollow tube has a length;
wherein the cable has a length which is substantially greater than the length of the second hollow tube;
wherein the hand held device for blowing hot air can be configured to blow hot air on the outer peripheral surface of the second hollow tube, in the first state, to cause the second hollow tube to shrink and become attached to the cable to repair a defect in the cable;
wherein the length of the second hollow tube is approximately equal to a width of an opening of a second device which can be attached or detached from hand held device for blowing hot air, and wherein hot air is blown out of the opening of the second device, in the first state, and
wherein the length of the first hollow tube and the length of the second hollow tube are different.

5. The apparatus of claim 1 wherein
and wherein the hand held device for blowing hot air can be configured to blow hot air on the outer peripheral surface of the first tube, in the first state, to cause the first tube to shrink and become attached to the cable, to repair a defect in the cable.

6. A method comprising the steps of:
sliding a first hollow tube over a first cable so that a portion of the first cable resides in an inner chamber of the first hollow tube in a first state;
blowing hot air on an outer surface of the first hollow tube in the first state, to thereby shrink the first hollow tube to cause the first hollow tube to become attached to an outer surface of the first cable;
wherein the first hollow tube is configured to have an inner diameter which is greater than an outer diameter of the first cable so that the first hollow tube can be slid over the first cable, so that a portion of the first cable resides in the inner chamber of the first hollow tube in the first state;
wherein the first hollow tube has a length; and
wherein the first cable has a length which is substantially greater than the length of the first hollow tube.

7. The method of claim 6 wherein
the step of blowing hot air on an outer surface of the first hollow tube in the first state includes blowing hot air from a hair dryer.

8. The method of claim 6 wherein
the length of the first hollow tube is approximately equal to a width of an opening of a first device which can be attached or detached from a hand held device for blowing hot air, and wherein the step of blowing hot air on an outer surface of the first hollow tube in the first state includes blowing hot air out of the opening of the first device attached to the hand held device for blowing hot air.

9. The method of claim 8 further comprising
sliding a second hollow tube over a second cable so that a portion of the second cable resides in an inner chamber of the second hollow tube in a first state;
blowing hot air on an outer surface of the second hollow tube in the first state, to thereby shrink the second hollow tube to cause the second hollow tube to become attached to the second cable, and to thereby repair a defect in the second cable;
wherein the second hollow tube is configured to have an inner diameter which is greater than an outer diameter of the second cable so that the second hollow tube can be slid over the second cable, so that a portion of the second cable resides in the inner chamber of the second hollow tube;
wherein the second hollow tube has a length; and
wherein the second cable has a length which is substantially greater than the length of the second hollow tube.
wherein the cable has a length which is substantially greater than the length of the second hollow tube;
wherein the length of the second hollow tube is approximately equal to a width of an opening of a second device which can be attached or detached from the hand held device for blowing hot air, and wherein hot air is blown out of the opening of the second device; and
wherein the length of the first hollow tube and the length of the second hollow tube are different.

10. The method of claim 6 wherein
the step of blowing hot air on an outer surface of the first hollow tube in the first state, to thereby shrink the first hollow tube to cause the first hollow tube to become attached to an outer surface of the first cable, repairs a defect in the cable.
